(19) United States
(12) Patent Application Publication
(10) Pub. No.: US 2010/0094773 A1
(43) Pub. Date: Apr. 15, 2010

(54) WEB BASED VALUATION GAME

(76) Inventor: Andrew Knight Simpson, Kenwood, CA (US)

Correspondence Address: FULBRIGHT AND JAWORSKI LLP, 555 S. FLOWER STREET, 41ST FLOOR, LOS ANGELES, CA, 90071, US

(21) Appl. No.: 12/306,474

(22) PCT Filed: Jun. 26, 2007
(86) PCT No.: PCT/US07/72100

§ 371 Date: Dec. 7, 2009

Related U.S. Application Data
(60) Provisional application No. 60/805,837, filed on Jun. 26, 2006.

(51) Int. Cl. G06Q 40/00

(52) U.S. Cl. 705/36 R

(57) ABSTRACT

A web enabled game analyzes businesses by categorizing companies by markets then drilling down to data charts including interactive assessment of private and public company values within those markets.

### CROSS REFERENCE TO RELATED APPLICATION

The present application claims the benefit of U.S. Provisional Patent Application No. 60/805,837 in the name of A. Simpson, filed on Jun. 26, 2006, the disclosure of which is expressly incorporated by reference herein in its entirety.

### FIELD OF THE INVENTION

The present invention relates to online computer games. More specifically, it relates to using online game technology to enable companies and investors to more accurately value company debt and equity securities.

### BACKGROUND

A central problem of corporate strategy and finance is estimating likely stock price and bond rating/bond yield outcomes from company decisions. This problem has been dramatized by the collapse of Enron, the subsequent introduction of Sarbanes-Oxley legislation, and the increased focus on accountable and transparent corporate decision making. There is an opportunity for investors, “C” level decision makers and board members to more accurately estimate companies' equity and debt securities' value—as a mirror to company decision making—within a computer game context. Such a system would facilitate strategy and operational decision making and also create a logical backbone—focused on capital markets valuation measures—for managing an entire information technology system for small, medium and large companies, both privately held and publicly traded.

### SUMMARY

According to an aspect of the present invention, a computer gaming method evaluates a company. The method includes receiving a company selection including an indication of whether a company is an end user company or a commodity company. The method also includes calculating an estimated value of the selected company and its underlying securities expressed either as a stock price or bond yield. The method further includes graphically displaying an icon that an end user moves to vary an underlying assumption of the estimated value. The method also includes graphically displaying, in real time, a representation of the estimated value of the selected company based upon the varying end user selected assumption.

In another aspect of the present invention, a computer readable medium stores a program for a computer game for evaluating a company. The medium includes a receiving code segment that receives a company selection including an indication of whether a company is an end user company or a commodity company. The medium also includes a calculating code segment that calculates an estimated value of the selected company. The medium further includes an icon displaying code segment that graphically displays an icon that an end user moves to vary an underlying assumption of the estimated value. The medium also includes a value displaying code segment that graphically displays, in real time, a representation of the estimated value of the selected company based upon the varying end user selected assumption.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts throughout several views of the drawings, and in which:

FIG. 1 show an exemplary taxonomy, according to an aspect of the present invention;

FIG. 2 shows a simple business classification, according to an aspect of the present invention;

FIG. 3 shows exemplary classes of commodity companies, according to an aspect of the present invention;

FIG. 4 shows an exemplary dashboard, according to an aspect of the present invention;

FIG. 5 shows an exemplary predicted versus actual stock price dashboard, according to an aspect of the present invention;

FIG. 6 shows yet another exemplary dashboard, according to an aspect of the present invention;

FIG. 7 shows an exemplary stock price and bond yield dashboard, according to an aspect of the present invention;

FIG. 8 shows exemplary input data;

FIGS. 9-15 show charts illustrating derivation of exemplary benchmark scores;

FIG. 16 shows exemplary regression analysis data; and

FIG. 17 shows exemplary output data.

### DETAILED DESCRIPTION

This system mounts corporate classification, strategy and finance analysis on a game-like web-based dashboard that may be manipulated by individuals or groups, over the Web.

According to an embodiment of the invention, a digitized taxonomy is provided for classifying entities, events, or things that the user may manipulate to “drill down”—e.g., rightward and downward—to subcategories that are typically predefined by the user. In one embodiment, the categories may be edited by the user to accommodate new categories.

In another aspect, a unique simple business classification system for the entire sphere of commerce is used within the taxonomy: end user companies and commodity companies. In this business classification, a user “drills down” to find markets and to evaluate individual companies.

This binary classification premise is a significant simplifying innovation relative to the widely used North American Industrial Classification System (NAICS) managed by the U.S. Census Bureau. NAICS has over 2000 classification entries arrayed in the format of Table 1.

TABLE 1

| | 2007 | |
|---|---|---|
| | NAICS | |
| 1 | Code | 2007 NAICS Title |
| 2 | | |
| 3 | 111110 | Soybean Farming |
| 4 | 111120 | Oilseed (except Soybean) Farming |
| 5 | 111130 | Dry Pea and Bean Farming |
| 6 | 111140 | Wheat Farming |
| 7 | 111150 | Corn Farming |
| 8 | 111160 | Rice Farming |
| 9 | 111191 | Oilseed and Grain Combination Farming |
| 10 | 111199 | All Other Grain Farming |
| 11 | 111211 | Potato Farming |
| 12 | 111219 | Other Vegetable (except Potato) and Melon Farming |
| 13 | 111310 | Orange Groves |
| 14 | 111320 | Citrus (except Orange) Groves |
| 15 | 111331 | Apple Orchards |
| 16 | 111332 | Grape Vineyards |
| 17 | 111333 | Strawberry Farming |

A solution begins with commodity and end user companies and branches downward in a web-based, game-like format to subcategories. The binary classification derives from a unique insight into the capital markets: all companies may be valued as “bets” or options on either commodity prices applied to a company's commodity reserve base (as is the case with oil, gas, mining and certain other commodity companies), or “bets” or options on the ability of management to build an end user (or customer) base as is the case with manufacturing and service companies, referred to as end user companies.

Thus, within the taxonomically displayed business classification system, a unique method is provided for valuing common stocks as de facto options according to industry classification.

In still another aspect, a unique dashboard solution enables the user, having drilled down from markets to individual companies, to interactively assess the value of private companies and public companies. In one embodiment, the valuation uses both conventional measures, such as present value of cash flow and multiples of earnings or “EBITDA” (earnings before interest, taxes, depreciation and amortization). The valuation may also use an adaptation of option pricing mathematics to value the common stocks of publicly traded companies, as described in “Using Option Pricing To Predict Market Values Of Publicly Traded Mining Companies” by SIMPSON et al. published in Mining Engineering February 2000, the disclosure of which is expressly incorporated by reference herein in its entirety.

In another aspect, server-side code and a database contain business market classification data for the taxonomy, business and valuation data and formulas for charting and valuing businesses within the taxonomy, and code for graphics manipulated on Web pages generated by applications, such as Coldfusion and Flash. This server-based code enables the protection of the code and data underlying the taxonomy and company data including valuation, even while the user or client is manipulating the graphic user interfaces including “digital dashboards” to see valuation outcomes on the Web.

End users, such as company officers seeking to evaluate strategy or finance alternatives, log on to a web page (which is typically password protected) via an Internet connection on a desktop computer or other device. Once into the website, the user may drill down via the taxonomy to a given market (or submarket) and then within that market to a given company. The user may access content, such as a production data chart, or may access an interactive dashboard for valuation of a given company. The taxonomy and charts and dashboards are accessible from the Web but the formulas and data underlying these visual representations preferably reside in a protected database on a server and may not be seen by the user except with special access permission.

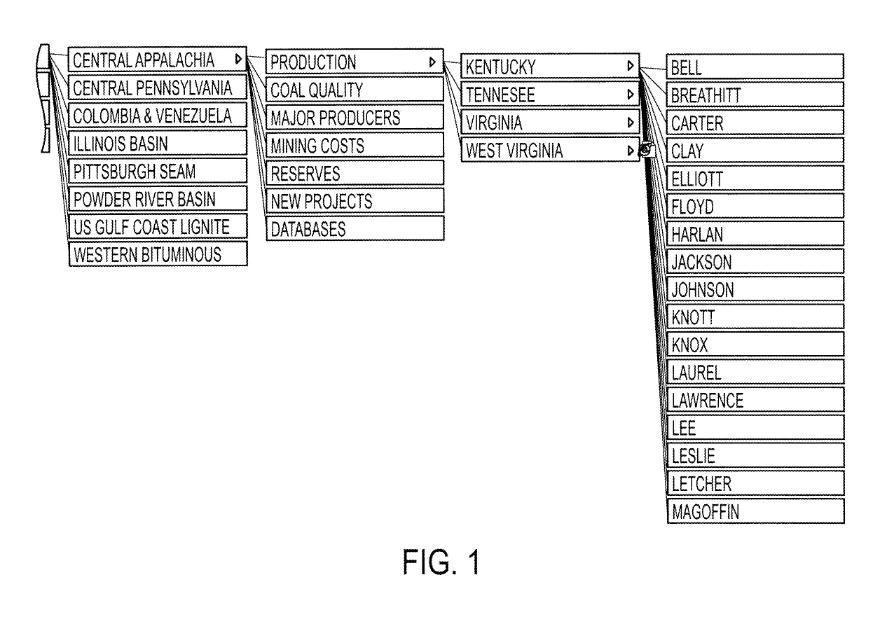

In one embodiment, rectangular visual images are displayed, using for example FLASH programming, that resemble a rightward and downward-growing organization chart. FIG. 1 shows an exemplary taxonomy's deployment. Although rightward and downward are discussed, any method of display to accomplish the selection visualization can be substituted. The taxonomy shown in FIG. 1 is an application of the taxonomy to classifying U.S. domestic markets in the coal industry. For example, the first level of “drill down” is the region, such as Central Appalachia; the second level are different data sets to describe a given region, such as production data; the third level is production data by state within Central Appalachia; the fourth level is county within a given state. The U.S. coal industry is one limited example presented merely for the purposes of explanation.

A unique simple business classification system is provided for the entire sphere of commerce. In addition to the rightward/downward propagating visual interface, a unique classification technique for commercial markets globally is used to analyze markets and companies within the format of the taxonomy shown in FIG. 1. In one embodiment, the premise is that there are only two basic types of company:
Commodity companies
End user companies

Commodity companies sell homogenous or nearly homogeneous products such as gold, copper, or natural gas. These products or related securities are typically sold in trading markets. These products sell almost exclusively on the basis of volume or weight, and price.

Nearly all other companies are end user companies. End user companies sell cars, movies, pharmaceuticals, books, consulting advice, securities brokerage, health services, etc. These companies' products and services sell on an array of attributes including price, service, features and benefits.

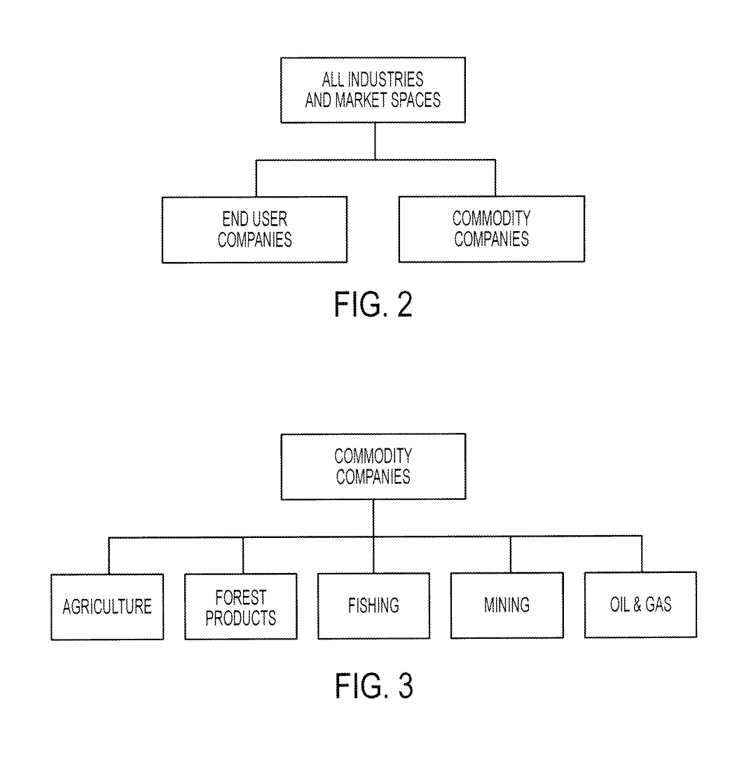

All companies are classified as falling under the two basic industry categories as shown in FIG. 2. Branching occurs, e.g., downward, Genome-style, to industry subcategories as shown in FIG. 3.

FIG. 3 shows as examples of Commodity Company subcategories Agriculture, Forest Products, Fishing, Mining and Oil and Gas. Others which meet the foregoing definition of commodity company may also be included.

A unique method is provided for valuing common stocks as de facto options according to industry classification. In one embodiment, common stocks of publicly traded commodity companies (such as gold or silver) are valued as call options on their reserves. In another embodiment, common stocks of end user companies are valued as call options on their end user bases.

With respect to commodity companies, the Black Scholes model is used in an embodiment, as seen in equation (1) below.

$$C = SN ( {d}_{1} ) - K {e}^{- rt} N ( {d}_{2} ) \\ Where \text{:} \\ {d}_{1} = \frac{ln ( S / X ) + ( r + {s}^{2} / 2 ) t}{s √ t} \qquad ( 1 )$$

C=Theoretical Call Premium
S=Current Stock Price
T=Time Until Option Expiration
K=Option Striking Price
R=Risk Free Interest Rate
N=Cumulative Standard Normal Distribution
E=Exponential Term (2.7183)

d₂=d₁₋s√t
s=Standard Deviation of Stock Returns
In=Natural Logarithm

In order to understand the Black Scholes model itself, it is divided into two parts. The first part, SN(d1), derives the expected benefit from acquiring a stock outright. This is found by multiplying stock price [S] by the change in the call premium with respect to a change in the underlying stock price [N(d1)]. The second part of the model, Ke ^{-rt}N(d₂), gives the present value of paying the exercise price on the expiration day. The fair market value of the call option is then calculated by taking the difference between these two parts.

In one embodiment, the calculation is modified by substituting reserve “half life” for option life (t=time until expiration in equation (1)), substituting commodity spot price for the price of the underlying (in equation (1), the underlying is S=current stock price), and substituting breakeven cash operating cost for the exercise price (K=option striking price in equation (1)).

A mining example will now be provided. Assume a gold mine has 1 million ounces of producing reserves, 100,000 ounces of annual production—therefore a 10 year mine life; a $500 spot price for gold and a $200 breakeven cash operating cost (including mining and all administrative cash costs but excluding depreciation and amortization). Assume this gold mining company sells gold in the spot market and not under long-term contract. Assume further that this company has 10 million shares outstanding, and that this company is publicly traded on a major exchange in the U.S. or abroad. What is the estimated stock price for this publicly traded gold mining company?

The option value is estimated for a single ounce of gold by inputting the following data into a standard Black Scholes options value calculator: vanilla call, 5 year option expiry period (mine half life), $500 stock price, $200 strike price, 30% volatility (assumed deviation of gold price), and 5% cost of money (five year US government debt cost). The option value per ounce is $344. The producing reserve is one million ounces. The company's enterprise value is $344 times one million ounces=$344 million. Assuming no debt and no cash on this gold producer's balance sheet, this also equals market capitalization. Hence $366 million divided by 10 million shares outstanding, the company's stock price is estimated to be $34.40 per share.

Similar principles apply to valuing end user companies' common stocks as call options on an end user base. In this case, estimated end user relationship life is the analog for reserve life. In order to initially validate the estimation for later use, the estimation is used with peer companies to determine its efficacy. The estimation is revised until the estimate predicts a stock price within the model, that is typically within 10%-20% error on a historical basis over a number of years.

As shown in Table 2 below, the underlying is estimated as the present value of revenues over the estimated Competitive Advantage Period (e.g., 7 years) divided by units produced over this period. The exercise price is estimated as the present value of cash expenses over the Competitive Advantage Period divided by forecast units produced over this same period. If multiple products are present, aggregation occurs. The strike price is represented as the breakeven cash cost of producing that product or service. The expiry period is the company's Competitive Advantage Period, or number of years average relationship duration across the customer or end user base.

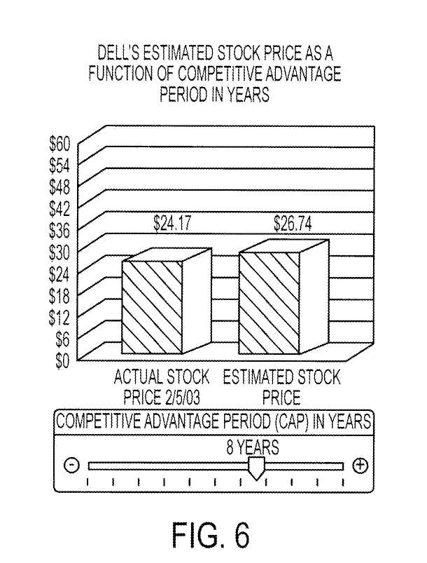

The table below is an excerpt from a hypothetical stock price valuation for an end user company. This shows how certain simple demonstration assumptions are made about a personal computer manufacturer with eight million customers each paying an average of $2000 on a periodic basis for personal computers with cost of sales of $1800 per customer per year. In order to value this company, first compute a value per customer of about $2400 then multiply this by average customer count of about 8 million customers over the eight year Competitive Advantage Period, to derive a market value of about $19 billion as shown in the table below. Applying this method to an exemplary company's (named Dell) stock price and assuming the slider is set at seven years in the interactive demo, the results are shown in FIG. 6.

TABLE 2
VALUATION OF HYPOTHETICAL
PERSONAL COMPUTER COMPANY

| | |
|---|---|
| Customer Revenues per Year | $2,000 |
| Customer Growth Rate | 10% |
| Cost of Sales Per Customer per year | $1,800 |
| Customer Relationship Average Life/yrs | 8 |
| Avg. Number of Customers(MM) | 8 |
| PV of Revenue(MM) | $72,727.3 |
| PV of Revenue/customer | $9,091 |
| PV of Service Delivery Costs(MM) | $65,454.5 |
| PV of Selling, General and Admin Expense(MM) | $133.4 |
| PV of Cash Operating Costs | $65,587.9 |
| PV of Operating Cost/customer | $8,198.49 |
| Debt-Cash | $0.0 |

Option Value of Each Customer

| | |
|---|---|
| Exercise Price = | $8,198 |
| Underlying = | $9,091 |
| Volatility | 10.00% |
| Int Rate | 5.00% |
| Half of Competitive Advantage Period in Years | 4.000 |
| Option Value/Customer | $2,422 |

Equity Value of Company = Sum of Option Values of Customers

| | |
|---|---|
| Avg Total Customers Over Competitive Advantage | 8.0 |
| Period(MM) | |
| Option Value per Customer | $2,422 |
| Company's Enterprise Value (MM) | $19,380 |
| Less debt + cash | $0.0 |
| =Equity Value of Public Company(MM) | $19,379.8 |
| divided by shares outstanding (MM) | 1,000 |
| Company Estimated Share Price | $19.4 |

Volatility is imputed according to customer growth rates, instead of variation in a price indicator. Government interest rates are employed, as in well known in option calculations. This method is useful for explaining and predicting stock price outcomes in end user companies, and may be especially useful for reviewing the likely valuation outcomes of alternative strategies.

FIG. 6 shows a 2003 analysis of Dell's stock price using option methods when Dell was focused mainly on the production and marketing of personal computers.

In one embodiment, a pre-revenue development stage company (end user or natural resource) uses a similar solution. Instead of using current operating cost data to estimate the exercise price, the net present value of cash operating cost is divided by units produced to create an input for the exercise price. In order to estimate the option life, the half life in years of the forecast horizon is used. Similarly, the net present value of future revenues divided by units produced is used to calculate an average price that constitutes the input for the underlying. Volatility is estimated as the forecast growth rate of the company over the forecast half life. Similar to the other applications, the risk free rate is estimated as the 10 year government bond yield, e.g., 5%.

Table 3 shows a non-operating mining company's valuation as an IPO candidate using the approach described above.

TABLE 3
HYPOTHETICAL VALUATION OF START UP MINING
COMPANY: NO REVENUE FIRST FIVE YEARS

| | |
|---|---|
| PV of Revenue (MM) | $575.2 |
| PV of Revenue/lb | $31.8 |
| PV of Extraction & Processing | $208.8 |
| PV of Admin | $59.9 |
| | $268.7 |
| PV of Mining Capital Costs | ($78.9) |
| PV of Milling Capital Costs | ($63.4) |
| PV of Capital Costs | ($142.3) |
| PV of Cost/lb | $14.8 |
| Option Value of 18.1 MM lbs: | |
| Exercise Price | $14.8 |
| Underlying = | $31.8 |
| Volatility | 20% |
| Int Rate | 5.20% |
| Option Life | 7.0 |
| Option Value/lb | $21.52 |
| Equity Value: | |
| Total Pounds Produced (MM) | 18.1 |
| Option Value per Pound | $21.52 |
| Company's Enterprise Value (MM) | $389.5 |
| Less PV of Capital Costs (MM) | ($142.3) |
| =Equity Value of Public Company (MM) | $247.3 |
| divided by shares O/S post IPO (MM) | 15.0 |
| Company's share price post IPO | $16.5 |

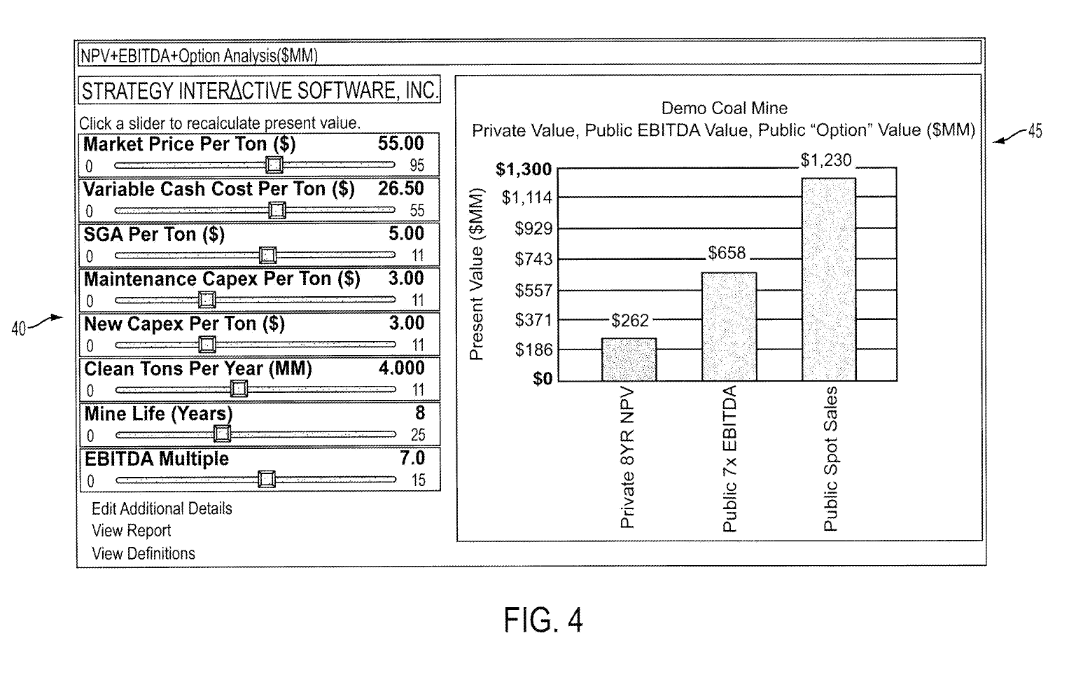

In one embodiment, unique dashboard solutions enable the user, having drilled down from markets to individual companies, to interactively assess the prospective private and public company value of of a given company. FIG. 4 shows a “Demo Coal Company” valuation dashboard to which a coal executive or analyst may have drilled down through a series of market subcategories to evaluate the likely valuation of “Demo Coal Company” as a private company, as a conventional public company which sells under long term contracts, and as a public company valued as an option, assuming it sells coal in the spot market (as if a gold company). FIG. 4 shows the input variables 40 on the left, including market price of coal, variable cash cost per ton of producing coal, etc. The user manipulates these assumptions by moving the “sliders” on this chart, which can be programmed in Cold Fusion. The output 45 is shown on the right. “Demo Coal Mine” is valued based on the input assumptions shown on the left. In this example, the user-selected methods of evaluation include:
a private company: “Private 8 Yr. NPV”—this means that the company is assumed to be a private company with an eight year mine life producing at $55/ton (see assumptions on sliders), that sells under long term contracts and is valued at $262 million.
a conventional publicly traded coal company: “Public 7× EBITDA”—this means that the company is assumed to have the same input assumptions as the privately held coal mine described immediately above, except that it is publicly held and is valued at 7× earnings before interest taxes depreciation and amortization (“EBITDA”), at $658 million, or more than twice the same company if valued as a private company
a publicly traded coal company that sells at spot: “Public Spot Seller”—this means that the company is assumed to be identical to the public coal company described immediately above except that it sells coal in the spot market instead of under long term contract, and is valued, instead, as a call option on its reserves, at an estimated value of $1.2 billion.

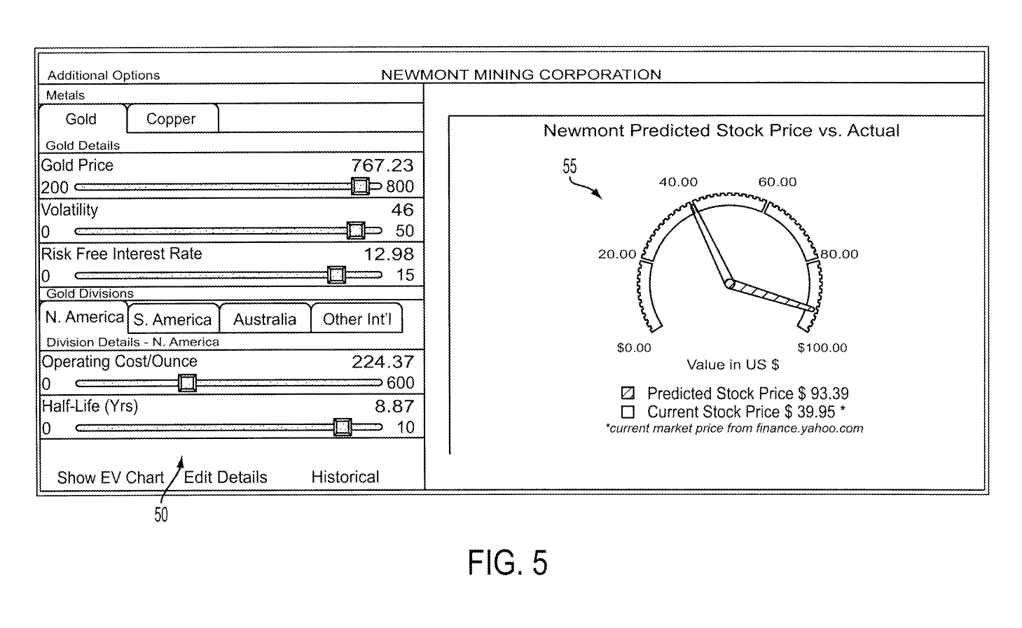

FIG. 5 illustrates a narrower example that shows a company's estimated public company value and its company value reported from a stock price database. The dashboard enables a user to manipulate various operating assumptions 50, such as the cash cost of mining, and market assumptions such as the price of gold/copper to see how the stock price 55 would likely react, under varying environments including hypothetical scenarios such as dramatic increase/decrease in gold and/or dramatic increase/decrease of cash operating costs. The system may be used to evaluate the likely impact on stock price of significant mergers, acquisitions, significant investments and divestitures.

The user manipulates sliders on the dashboard. The sliders are linked to math formulae. Changes in sliders are reflected in changed values in the formulae. The changes in the variables generate changes in the enterprise metrics 55, which are displayed on the right side. The web site connects the user to the database, which the user cannot visually inspect. This enables the use of proprietary data and algorithms the user might not otherwise be able to access.

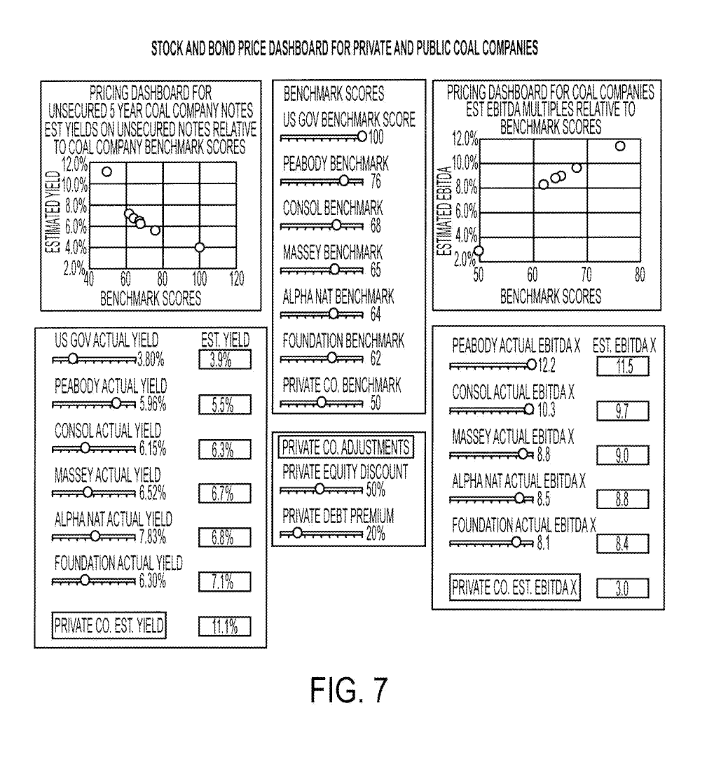

In one embodiment, there is a debt and equity dashboard solution that enables the user to view both debt cost and equity value outcomes based on varying inputs to a web-based dashboard. FIG. 7 shows this approach for analyzing the valuation of coal companies, both public and private. In this particular application the publicly traded coal companies reviewed are primarily contract sellers of coal, and do not sell most of their coal at spot prices. Because these companies are primarily valued by the public market as “EBITDA” companies—meaning they are valued on multiples of EBITDA—the solution provides EBITDA multiple analysis for the equity values of coal companies instead of the option method more fruitfully applied to spot sellers of coal; the solution provides, in a companion graph, the estimated debt cost of each coal company for whom an equity value estimate is provided.

The ability to interactively estimate both debt and equity valuation outcomes in a game-like dashboard mounted on the Web is without precedent in the U.S. and global capital markets. The solution deploys an interactive database containing a unique benchmarking system for equity and debt analysis. This benchmarking system entails debt cost estimation based on the use of subjective credit scoring methods by industry experts with respect to intangibles such as management quality and combines these with customary credit ratios to create a benchmark score. These benchmark scores are then correlated with existing bond yield data in the public market for the coal companies shown using a log-linear regression analysis. This method shown below establishes a clear functional relationship between credit quality and the market measure of credit quality, debt cost.

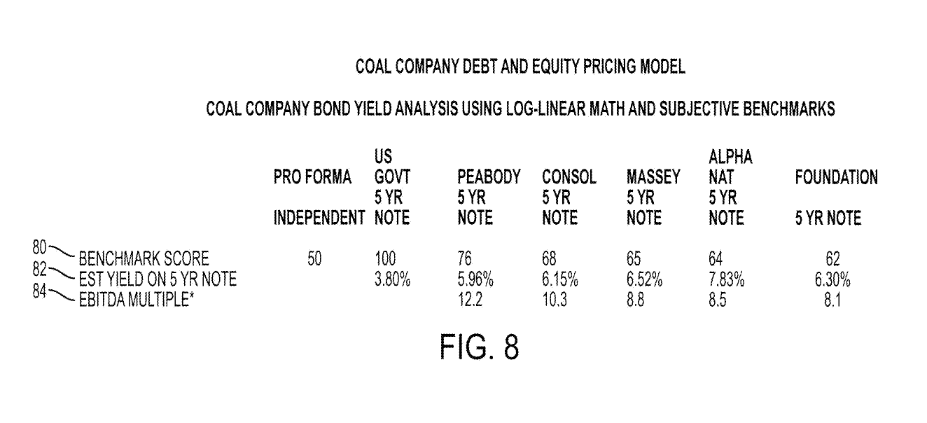

FIG. 8 shows exemplary key data inputs for the dashboard shown in FIG. 7 exemplifying the Coal Company Debt and Equity Valuation Model. The key input, Benchmark Score 80, is taken from a separate feeder program (discussed below) that estimates the overall viability of the companies reviewed. The Benchmark Score is based on expert estimates of business fundamentals, such as management quality and other business attributes in addition to a quantitative scoring of standard quantitative financial ratios, such as cash flow/debt and cash flow/interest. An expert's subjective scoring of business fundamentals is performed on the web enabled interactive analytical system called Investment Benchmarking and takes the format described below. The yield on the five year note 82 and EBITDA data 84 is gathered from known sources.

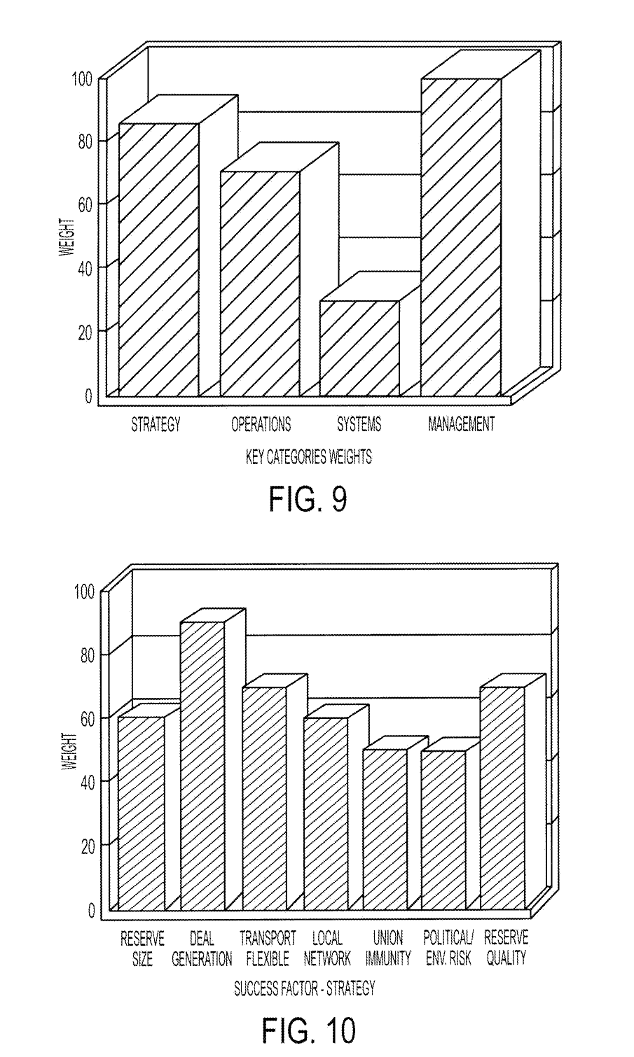

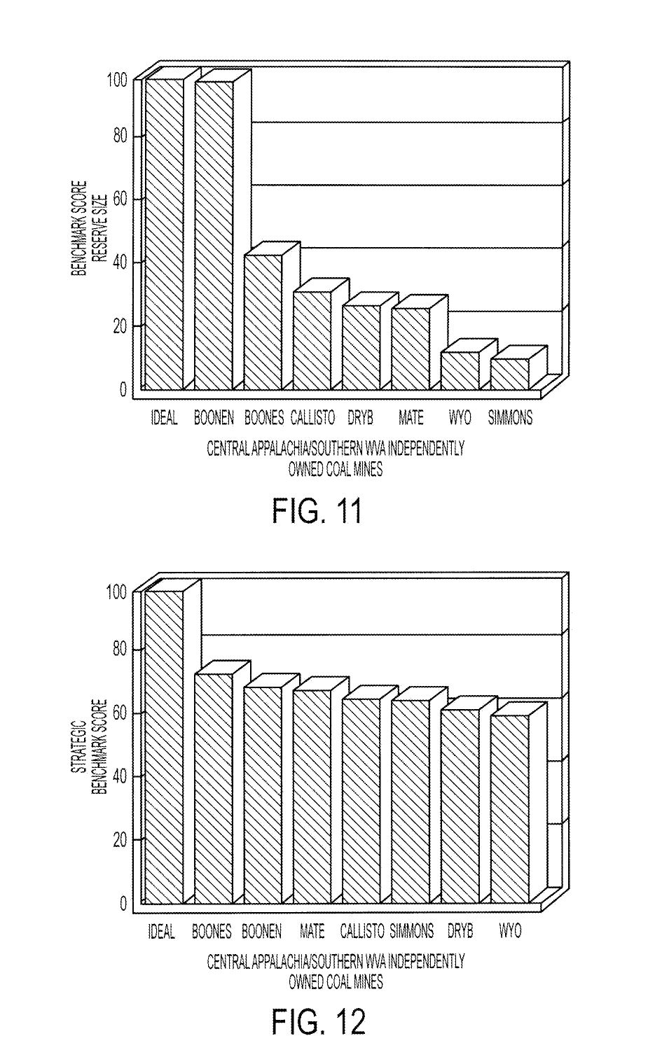

The Benchmark Score analysis is now discussed. Initially, categories are defined and weighted for the evaluation of business fundamentals, such as the overall quality of company strategy, management and other elements as shown in FIG. 9. Subjective judgments of industry experts, such as retired CEOs, determine the weights. Then subcategories are defined in each main category such as, for a mining company's strategy, variables such as reserve size, the ability to generate new acquisition deals (“deal generation”), flexible transportation alternatives (“transport flexible”) such as rail, barge or truck, etc., as shown in FIG. 10. The experts help determine the subcategories. Then with expert assistance, each of the strategic variables, such as reserve size across a peer group are evaluated, as shown in FIG. 11. Then, each peer company's score is summed in relation to the ideal and in relation to one another to create a benchmark score on strategic variables as shown in FIG. 12 for coal companies in Southern West Virginia.

As shown in Table 4, a quantitative analysis is performed on these same peers on these variables with their respective weightings, which are based upon well known credit research bankruptcy prediction to create a financial benchmarking.

TABLE 4

| Element | Weight |
|---|---|
| Leverage | 30% |
| Equity cushion | 42% |
| Profitability | 100% |
| Liquidity | 36% |
| Size | 30% |

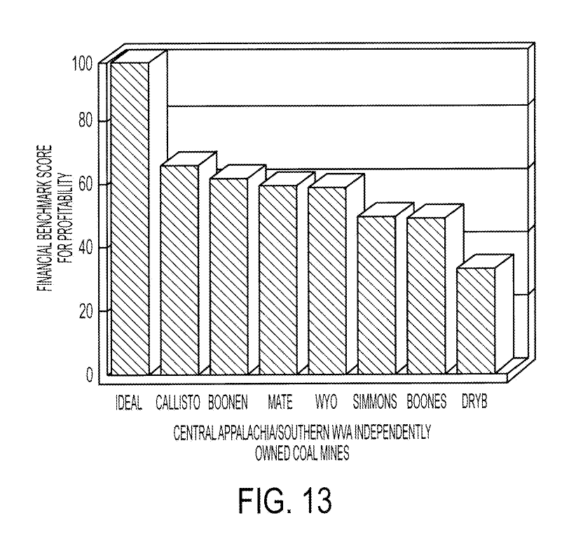

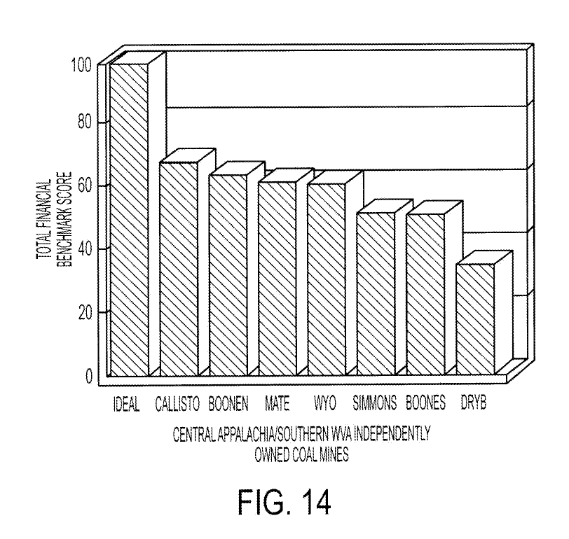

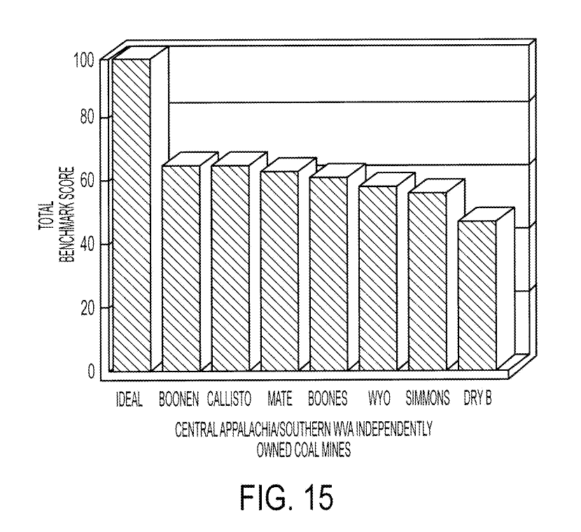

Each company is then evaluated on each financial variable relative to the ideal, as seen in FIG. 13. Next, each company's weighted financial score is summed to create an overall financial benchmark score as seen in FIG. 14. Finally, financial and strategic benchmark scores are combined to derive the Total Benchmark Score as shown in FIG. 15.

The foregoing is an example for privately held coal companies in West Virginia. The following model relates to U.S. coal companies with publicly traded debt and equities.

Once the Benchmark Scores are known, as shown in FIG. 8, combining both business and financial variables, this Benchmark Score can be used to calculate bond yields and EBITDA multiples in the digital dashboard shown in FIG. 7.

Initially, the second key variable 82 is input. The second key variable is the estimated public market bond yield which can be take from published sources including the Wall Street Journal and online sources. For example, at the time when the example in FIG. 8 was generated, Peabody's 5 year note yield was 5.96%. The EBITDA multiple 84 shown in FIG. 8 may also be taken from published sources such as Yahoo Finance or may be calculated as: (today's stock price×shares outstanding+all debt−cash)/latest twelve months' earnings before interest, taxes, depreciation and amortization.

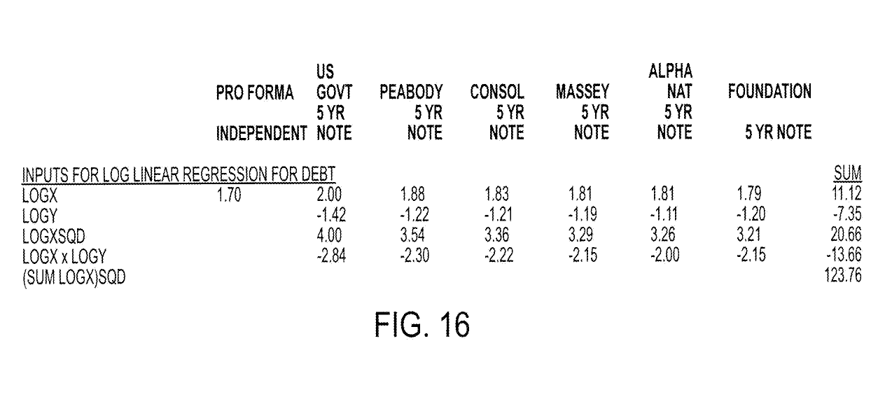

FIG. 16 shows how standard log linear regression analysis can be used to determine bond yields based on statistically modeling the expected bond yields associated with a given Benchmark Score. Although not shown in detail estimated EBITDA scores will also be explained.

To calculate the value, six sources will be used, i.e., “n”=6, in the example shown in FIGS. 8 and 16. The Company's Benchmark Score is converted to its common logarithm: e.g., for Peabody's Benchmark Score of 76, its logarithm is 1.88 as shown in the Log X row of FIG. 16. Next, the Company's bond yield 82 is converted to its common logarithm; e.g., for Peabody its 5.96% bond yield appears in logarithm form as −1.22 in the Log Y row of FIG. 16. Also calculated are LogX squared, LogX×LogY, and the (Sum of LogX)²), as shown in their respective rows of FIG. 16.

An ordinary regression analysis is performed on the Y variables (company bond yields converted to logarithms) and on the X variables (company Benchmark Scores converted to logarithms). To derive the equation for estimating bond yields, the equation (2) is used.

Log Y=a+b×Log X, (2)
where a=Sum of LogY/n-b(Sum of LogX)/n b=(n(Sum(LogX×LogY)−(Sum Log X)×(Sum Log Y))/(n(Sum Log X²)−(Sum×LogX)²

In this example, a=1.077605668; and b=−1.241763428. Thus, LogY=1.08-1.24 LogX in this example.

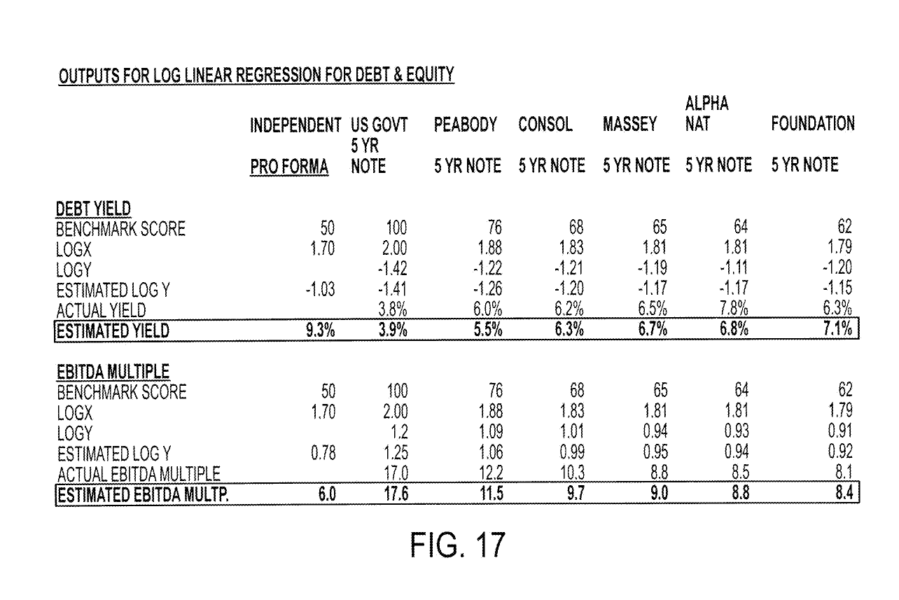

Once the predictive equations are known for Company debt yields as a function of the Company Benchmark Score, then a predictive equation is similarly calculated for Company EBITDA multiples by substituting EBITDA multiples 84 for debt yields 82 in the equation (2) to generate a Company EBITDA multiple estimator. Then, the estimates of Company debt yield and EBITDA multiple are combined and shown on the output in FIG. 17, which then becomes the basis of the interactive dashboard for Coal Company Debt and Equity Valuation of FIG. 7. It is noted that the actual bond and equity values are shown in FIG. 17, labeled “actual yield” and “actual ebitda multiple” and are determined from actual market data. It is also noted that a private debt premium of 20% and a private equity discount of 50% can be used, as reflected in the private company estimated yield, and private company estimated EBITDA shown in FIG. 7.

The overall application uniquely bridges corporate finance and business strategy formulation and strategic information systems for running small, medium and large enterprises. This solution rolls up and applies all significant quantitative information in a major enterprise to the problems of corporate governance by showing the likely risk and return consequences of decisions expressed in bond yield and stock price whether for public or private companies.

Because of its visual clarity, this solution uniquely enables strategic dialog in real time among board members and C-level execs who may be looking at a common web screen from geographically disparate locations and discussing the same telephonically. If viewed from wireless handheld device, it enables analysis and decision making from non-office locations.

### Server-Side Code and Database

In one embodiment, the application runs on Internet Information Services (IIS), MySQL, and Coldfusion servers to house and manipulate the online taxonomy, graphics and dashboards. Other platforms may be used. The security of data and formulae reside in non-end user servers. Nevertheless, the end users have the ability to interactively assess likely valuation outcomes on the Web in his/her market, peer competitive arena, or specific company, using this innovative combination of taxonomic and analytical tools.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., IIS), represent examples of the state of the art. Such standards are periodically superseded by faster or more efficient equivalents having essentially the same functions. Accordingly, replacement standards and protocols having the same functions are considered equivalents.

What is claimed:

1. A computer gaming method for evaluating a company, comprising:
receiving a company selection including an indication of whether a company is an end user company or a commodity company;
calculating an estimated value of the selected company;
graphically displaying an icon that an end user moves to vary an underlying assumption of the estimated value; and
graphically displaying, in real time, a representation of the estimated value of the selected company based upon the varying end user selected assumption.

2. The computer gaming method according to claim 1, further comprising:
obtaining an actual stock price of the selected company; and
graphically displaying a representation of the actual stock price to enable a visual comparison between the actual stock price and the calculated value.

3. The computer gaming method of claim 1, further comprising displaying categories and subcategories in response to receiving the indication.

4. The computer gaming method of claim 3, in which the displaying categories and subcategories comprises displaying each successive subcategory to the right and below a previous subcategory.

5. The computer gaming method according to claim 1, in which the estimated price comprises a stock price.

6. The computer gaming method according to claim 1, in which the estimated price comprises a bond price expressed as a bond yield.

7. The computer gaming method according to claim 1, in which the estimated price comprises a bond price expressed as a bond yield and a stock price.

8. The computer gaming method according to claim 1, in which the estimated value is based upon proprietary data, the proprietary data being stored on a protected server.

9. The computer gaming method according to claim 1, in which the estimated value is calculated based upon the equation LogY=a+b×LogX,
where a=Sum of LogY/n-b(Sum of LogX)/n and b=(n(Sum(LogX×LogY)−(Sum LogX)×(Sum LogY))/(n(Sum Log X²)−(Sum LogX)².

10. The computer gaming method according to claim 1, wherein the estimated value accounts for either a private debt premium or a private equity discount.

11. A computer readable medium storing a program for a computer game for evaluating a company, comprising:
a receiving code segment that receives a company selection including an indication of whether a company is an end user company or a commodity company;
a calculating code segment that calculates an estimated value of the selected company;
an icon displaying code segment that graphically displays an icon that an end user moves to vary an underlying assumption of the estimated value; and
a value displaying code segment that graphically displays, in real time, a representation of the estimated value of the selected company based upon the varying end user selected assumption.

12. The medium according to claim 11, further comprising:
a stock price code segment that obtains an actual stock price of the selected company; and
a stock price displaying code segment that graphically displays a representation of the actual stock price to enable a visual comparison between the actual stock price and the calculated value.

13. The medium of claim 11, further comprising a category displaying code segment that displays categories and subcategories in response to receiving the indication.

14. The medium of claim 13, in which the categories displaying code segment displays each successive subcategory to the right and below a previous subcategory.

15. The medium according to claim 11, in which the estimated value comprises a stock price.

16. The medium according to claim 11, in which the estimated value comprises a bond price expressed as a bond yield.

17. The medium according to claim 11, in which the estimated value comprises a bond price expressed as a bond yield and a stock price.

18. The medium according to claim 11, in which the estimated value is based upon proprietary data, the proprietary data being stored on a protected server.

19. The medium according to claim 11, in which the estimated value is calculated based upon the equation LogY=a+b×LogX,
where a=Sum of LogY/n-b(Sum of LogX)/n and b=(n(Sum(LogX×LogY)−(Sum LogX)×(Sum LogY))/(n(Sum Log X²)−(Sum LogX)².

20. The medium according to claim 11, wherein the estimated value accounts for a private debt premium and/or a private equity discount.
